(19) United States
(12) Patent Application Publication
(10) Pub. No.: US 2013/0215237 A1
(43) Pub. Date: Aug. 22, 2013

(54) IMAGE PROCESSING APPARATUS CAPABLE OF GENERATING THREE-DIMENSIONAL IMAGE AND IMAGE PICKUP APPARATUS, AND DISPLAY APPARATUS CAPABLE OF DISPLAYING THREE-DIMENSIONAL IMAGE

(71) Applicant: CANON KABUSHIKI KAISHA, (US)

(72) Inventors: Chiaki Inoue, Utsunomiya-shi (JP); Atsushi Okuyama, Tokorozawa-shi (JP)

(73) Assignee: CANON KABUSHIKI KAISHA, Tokyo (JP)

(21) Appl. No.: 13/768,126

(22) Filed: Feb. 15, 2013

(30) Foreign Application Priority Data
Feb. 17, 2012 (JP) 2012-032773

(51) Int. Cl. H04N 13/02

(52) U.S. Cl. CPC H04N 13/025
USPC 348/49; 345/419

(57) ABSTRACT

An image processing apparatus includes an image obtainer configured to obtain a parallax image, an object extractor configured to extract at least a first object and a second object in the parallax image, a parallax amount calculator configured to calculate an amount of parallax of each of the first object and the second object, a viewing condition obtainer configured to obtain a viewing condition when a three-dimensional image is displayed, and a three-dimensional appearance determiner configured to, by using the viewing condition and the amounts of parallax of the first and second objects that are calculated by the parallax amount calculator, determine that a three-dimensional appearance is obtained when a difference between the amounts of parallax of the first and second objects is not less than a predetermined value, and determine that the three-dimensional appearance is not obtained when the difference is less than the predetermined value.

### BACKGROUND OF THE INVENTION

1. Field of the Invention

The present invention relates to an image processing apparatus, an image-pickup apparatus, and a display apparatus that are especially capable of controlling, acquiring, and displaying a three-dimensional image.

2. Description of the Related Art

Traditionally, it is known that harmful effects, such as a so-called “cardboard effect”, where an object in the image looks like a board, and a so-called “miniature effect”, where the image looks like a miniature, are caused in observation of a three-dimensional image due to parallax images. Measures of taking conditions of viewing and image-taking of the image into consideration are needed to avoid the above harmful effects.

However, the cardboard effect and the miniature effect are defined as distortion of the reproduction magnification when the three-dimensional image is reproduced in a prior art disclosed in Japanese Patent Laid-Open NO. 2005-26756. Since a viewer can feel the three-dimensional effect by parallax by viewing an image having parallax with right and left eyes, it is difficult to represent the harmful effects, which the viewer feels, with accuracy only by the distortion of the reproduction magnification.

### SUMMARY OF THE INVENTION

The present invention provides an image processing apparatus, an image pickup apparatus and a display apparatus that are capable of showing a more high-quality three-dimensional image by determining whether a harmful effect is caused in a three-dimensional image more accurately.

An image processing apparatus as one aspect of the present invention is capable of generating a three-dimensional image and includes an image obtainer configured to obtain a parallax image, an object extractor configured to extract at least a first object and a second object in the parallax image that is obtained by the image obtainer, a parallax amount calculator configured to calculate an amount of parallax of each of the first object and the second object that are extracted by the image extractor, a viewing condition obtainer configured to obtain a viewing condition when the three-dimensional image is displayed, and a three-dimensional appearance determiner configured to, by using the viewing condition and the amounts of parallax of the first and second objects that are calculated by the parallax amount calculator, determine that a three-dimensional appearance is obtained when a difference between the amounts of parallax of the first and second objects is not less than a predetermined value, and determine that the three-dimensional appearance is not obtained when the difference is less than the predetermined value.

An image pickup apparatus as another aspect of the present invention is capable of generating a three-dimensional image and includes an image pickup device configured to take an image of an object at different points of view to obtain a plurality of parallax images, an object extractor configured to extract at least a first object and a second object in the parallax image that is obtained by the image obtainer, a parallax amount calculator configured to calculate an amount of parallax of each of the first object and the second object that are extracted by the image extractor, a viewing condition obtainer configured to obtain a viewing condition when the three-dimensional image is displayed, a three-dimensional appearance determiner configured to, by using the viewing condition and the amounts of parallax of the first and second objects that are calculated by the parallax amount calculator, determine that a three-dimensional appearance is obtained when a difference between the amounts of parallax of the first and second objects is not less than a predetermined value, and determine that the three-dimensional appearance is not obtained when the difference is less than the predetermined value, and an image pickup apparatus controller configured to control the image pickup apparatus according to a determination result of the three-dimensional appearance determiner.

A display apparatus as another aspect of the present invention is capable of displaying a three-dimensional image, and includes an image obtainer configured to obtain a parallax image, an image display configured to display the parallax image obtained by the image obtainer, an object extractor configured to extract at least a first object and a second object in the parallax image that is obtained by the image obtainer, a parallax amount calculator configured to calculate an amount of parallax of each of the first object and the second object that are extracted by the image extractor, a viewing condition obtainer configured to obtain a viewing condition when the three-dimensional image is displayed, a three-dimensional appearance determiner configured to, by using the viewing condition and the amounts of parallax of the first and second objects that are calculated by the parallax amount calculator, determine that a three-dimensional appearance is obtained when a difference between the amounts of parallax of the first and second objects is not less than a predetermined value, and determine that the three-dimensional appearance is not obtained when the difference is less than the predetermined value, and a display apparatus controller configured to control the display apparatus according to a determination result of the three-dimensional appearance determiner.

Further features of the present invention will become apparent from the following description of exemplary embodiments with reference to the attached drawings.

### BRIEF DESCRIPTION OF THE DRAWINGS

FIG. 1 is a block diagram of an image processing apparatus in embodiment 1.

FIG. 2 is a flow chart of a processing in embodiment 1.

FIG. 3 is a block diagram of an image processing apparatus in embodiment 2.

FIG. 4 is a flow chart of a processing in embodiment 2.

FIG. 5 is a block diagram of an image image-pickup apparatus in embodiment 3.

FIG. 6 is a flow chart of a processing in embodiment 3.

FIG. 7 is a flow chart of a processing in embodiment 4.

FIG. 8 is a block diagram of an image-pickup apparatus in embodiment 5.

FIG. 9 is a flow chart of a processing in embodiment 5.

FIG. 10 is a block diagram of an image-pickup apparatus in embodiment 6.

FIG. 11 is a flow chart of a processing in embodiment 6.

FIG. 12 is a block diagram of an image-pickup apparatus in embodiment 7.

FIG. 13 is a flow chart of a processing in embodiment 7.

FIG. 14 is an explanation diagram of an image-taking model of a three-dimensional image.

FIG. 15 is an explanation diagram of a three-dimensional display model.

FIG. 16 is an explanation diagram relating to an offset control in the three-dimensional display model.

FIG. 17 is a supplementation chart of an object extraction.

FIGS. 18A-18B are explanation diagrams of a method for extracting correspondence points.

### DESCRIPTION OF THE EMBODIMENTS

In embodiments, the same principle as Japanese Patent Laid-Open No. 2005-26756 or the like is used as a method for taking and viewing a three-dimensional image (3D image).

3D parameters that relate to the three-dimensional image are five parameters on an image-taking side and three parameters on a viewing side.

The parameters on the image-taking side is a base length that is a distance between optical axes of two image taking cameras, a focal length in taking an image, the size of an image pickup element, an angle of convergence that is an angle between the optical axes of the image pickup cameras, and an object length.

The parameters on the viewing side are a display size in a television, which displays an image, or the like, a visual distance in viewing the television, the offset amount of adjusting positions of parallax images that are displayed on a screen of the television.

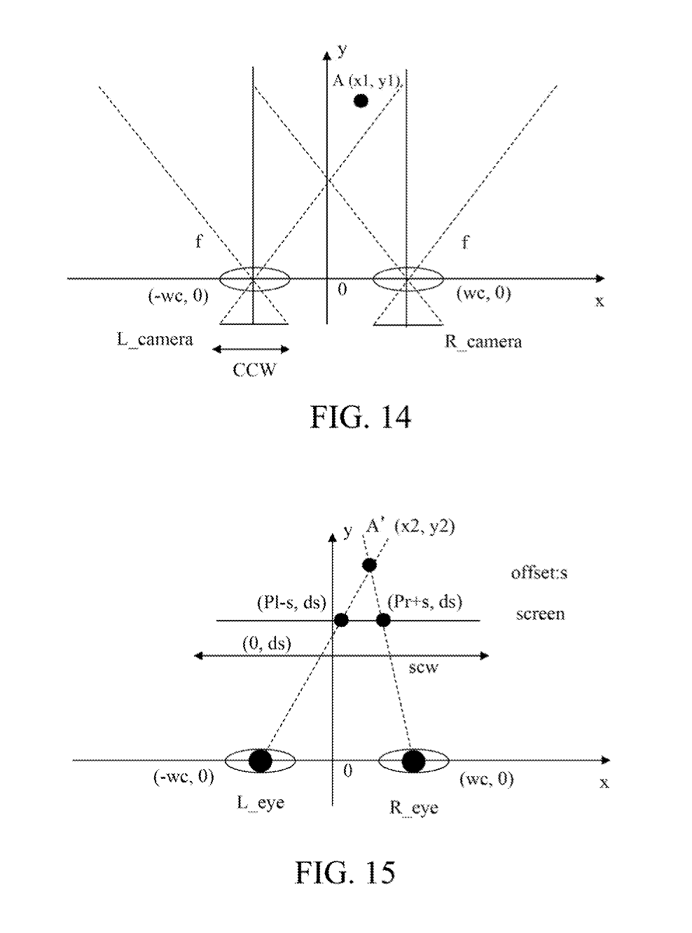

A method for controlling the angle of convergence (for inclining the axis of the camera) is proposed in conventional techniques, but the following will describe the principle in a parallel method of making the optical axes of the right and left cameras parallel to simplify the explanation. A similar geometrical theory can be used by taking into consideration a distance to a point of convergence in a method for controlling the angle of convergence. FIG. 14 illustrates a geometric relationship when an image of an arbitrary object is taken. Further, FIG. 15 illustrates a geometric relationship when the image is reproduced.

In FIG. 14, the middle of principal points of the right and left cameras (L_camera,R_camera) is defined as an origin, and a direction where the cameras lines up is defined as an x axis and a direction orthogonal thereto is defined as a y axis. The direction of height is omitted for simplification. The base length is defined as “2wc”. The right and left cameras have the same spec, and a focal length in taking an image is defined as “f” and a width of an image pickup element is defined as “ccw”. Further, a position of an arbitrary object A is defined as (x1, y1).

Images of the object A on right and left image pickup elements in the right and left cameras are geometrically positioned at an intersection between each of the image pickup elements and a straight line passing through a principal point of a lens. Therefore, the images on the right and left image pickup elements are formed at positions different from each other when the center of the image pickup elements is defined as a basis. The difference between positions gets less as the object distance gets more, and becomes 0 at infinity.

In FIG. 15, the center of the viewer's eyes (L_eye, R_eye) is defined as an origin, a direction in which the eyes lines up is defined as an x axis and a direction orthogonal thereto is defined as a y axis. The interval between the eyes is defined as “2we”. The visual distance from the viewer to the 3D television is defined as “ds”. The width of the 3D television is defined as “scw”.

Images taken by the above-mentioned right and left image pickup elements are overlapped and displayed on the 3D television. In the 3D television using a method of being viewed by wearing a liquid crystal shutter glasses, the right image and the left image are switched at high speed to be displayed. In a case that images of the image pickup elements that are taken using the parallel method are displayed with no change, reproduced three-dimensional images seems that the screen of the 3D television is located at infinity and all objects burst from the screen. Therefore, this case is undesired. For the reason, the object distance on the screen is properly adjusted by shifting the right and left images in the horizontal direction. The amount of the shift on the screen is defined as an offset amount (s).

Coordinates of a left eye image L and a right eye image R that are reproduced on the screen when the offset amount is 0 is respectively defined as (P1, ds) and (Pr, ds). Considering the offset, the coordinates can be respectively defined as L(Pl−s, ds) and R(Pr+s, ds).

An image A′ reproduced in three-dimension in viewing at the above condition is generated at a position (x2, y2) of the intersection of a straight line passing through the left eye and the left eye image and a straight line passing through the right eye and the right eye image. Hereinafter, the following will describe a geometrical configuration in detail.

A shift amount of an object image A from the center of the image pickup elements of the right and left cameras when the object A is taken is defined as an image-taking parallax amount and, when the amounts of parallax of the left eye image and the right eye image are respectively defined as Plc and Prc (not illustrated), the following expressions are obtained:

$$\begin{matrix}[ Expression 1 ] & \\ Right eye image Prc = \frac{wc - x 1}{y 1} \cdot f & ( 1 ) \\ [ Expression 2 ] & \\ Left eye image Plc = - \frac{wc + x 1}{y 1} \cdot f & ( 2 )\end{matrix}$$

When a ratio between the size of the image pickup element of the camera and the size of the 3D television is defined as a display magnification “m”, the “m” is represented by m=scw/ccw. The shift amount in taking an image on the screen of the television is calculated by multiplying by −m.

At this time, when the amount of parallax displayed in the three-dimensional display is defined as Pl and Pr in left and right, the following expressions are obtained:

[Expression 3]

Right eye image Pr=−m·Pr c (3)

[Expression 4]

Left eye image Pl=−m·Plc (4)

When an offset added to the right and left images in reproduction is defined as “s”, the position (x2, y2) of a reproduction image A′ to the viewer is represented by the following expressions:

$$\begin{matrix}[ Expression 5 ] & \\ x 2 = \frac{Pl + Pr}{2 we + Pl - Pr - 2 s} \cdot we & ( 5 ) \\ [ Expression 6 ] & \\ y 2 = \frac{2 we}{2 we + Pl - Pr - 2 s} \cdot ds & ( 6 )\end{matrix}$$

The images at the same object distance are reproduced on the same plane. Considering there is the object A on the y axis (x1=0) for further simplification of the explanation, a screen display position where the offset is not performed is represented by the following expressions:

$$\begin{matrix}[ Expression 7 ] & \\ Right eye image Pr = - m \cdot \frac{wc}{yl} \cdot f & ( 7 ) \\ [ Expression 8 ] & \\ Left eye image Pl = m \cdot \frac{wc}{yl} \cdot f & ( 8 )\end{matrix}$$

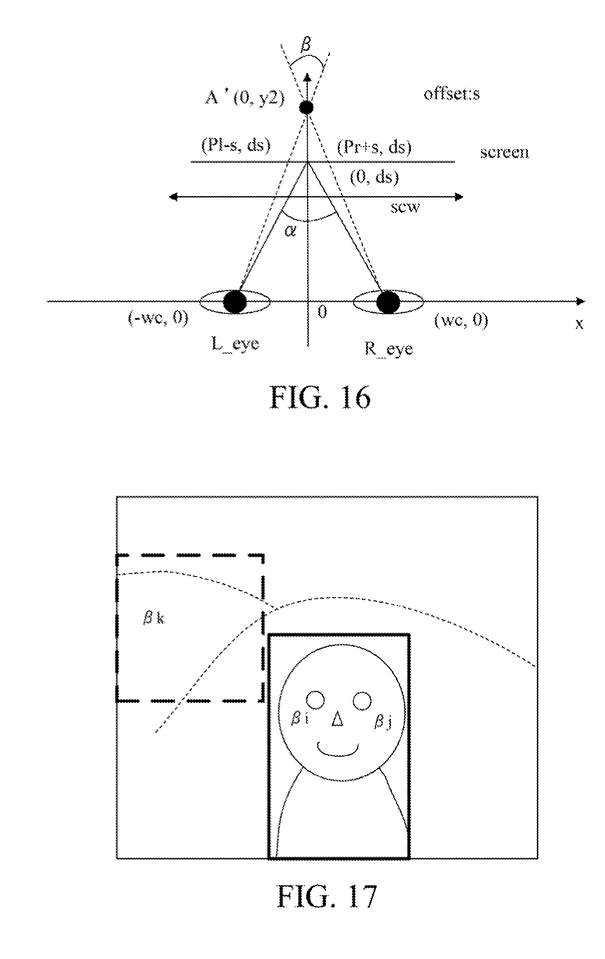

With regard to a position of a reproduction image after the offset is performed, the image A′ is generated at a position (0, y2) that is an intersection between a straight line passing through the left eye and the left eye image and a straight line passing through the right eye and the right eye image, as illustrated in FIG. 16. This is represented by the following expression:

$$\begin{matrix}[ Expression 9 ] & \\ y 2 = \frac{2 we}{2 we + Pl - Pr - 2 s} \cdot ds & ( 9 )\end{matrix}$$

When an angle of view of the viewer in the reproduction image is defined as “β” as illustrated in FIG. 16, the “β” is represented as the following expression using a reproduction distance “y2” and a interval between eyes “2we”:

$$\begin{matrix}[ Expression 10 ] & \\ β = 2 \cdot arctan \frac{we}{y 2} ≅ \frac{2 we}{y 2} & ( 10 )\end{matrix}$$

When the expression 9 is substituted for “y2”, the following expression is obtained:

$$\begin{matrix}[ Expression 11 ] & \\ β = 2 \cdot [ \frac{Pl - Pr}{2 ds} + \frac{we}{ds} - \frac{s}{ds} ] & ( 11 )\end{matrix}$$

When an angle at which the viewer views the screen of the 3D television is defined as “α” as illustrated in FIG. 16, the “α” is represented by the following expression:

$$\begin{matrix}[ Expression 12 ] & \\ α ≅ \frac{2 we}{ds} & ( 12 )\end{matrix}$$

Therefore, “α−β” is represented by the following expression:

$$\begin{matrix}[ Expression 13 ] & \\ α - β = - 2 \cdot [ \frac{Pl - Pr}{2 ds} - \frac{s}{ds} ] & ( 13 )\end{matrix}$$

This is an index that is so-called “relative parallax amount”. This size corresponds to a relative distance between the display screen and the object image A in a depth direction. In conventional various researches, it is known that a human senses a direction in the depth direction by calculating the difference of the angle in his brain.

Next, “flattening” will be described. The “flattening” is defined as a state where an arbitrary object and an object at infinity are indistinguishable in the depth direction in three-dimensional viewing (a state where a relative three-dimensional effect is obtained). In other words, flattening means that a state where an arbitrary object seems to stick to the background at infinity.

Flattening is a harmful effect that occurs in a distant object and therefore, first, the relative parallax amount of the object at infinity should be calculated. The amount of parallax (Pl−Pr) is assumed to become 0 in the parallel method, and the relative parallax amount to infinity is represented by the following expression:

$$\begin{matrix}[ Expression 14 ] & \\ α - {β}_{∞} = 2 \cdot \frac{s}{ds} & ( 14 )\end{matrix}$$

The amount of parallax of an object at a limited distant to the object at infinity is obtained by subtracting the expression 13 from the expression 14, and the expression is represented as:

$$\begin{matrix}[ Expression 15 ] & \\ β - {β}_{∞} = \frac{Pl - Pr}{ds} & ( 15 )\end{matrix}$$

The distant image in flattening seems plane, and therefore the amount of parallax to the object at infinity is required to be 0.

We subjectively assessed three-dimensional appearance of a distant object using a full HD 3D television and, as the result, known that there was a person who did not feel the parallax when the amount of parallax is less than three minutes to the object at infinity even if there was a parallax in the image. The expression 15 is not related to the interval between eyes 2we.

The amount of parallax in which it becomes difficult to obtain the three-dimensional effect is defined as allowable parallax lower limit δt (that is, a limit value where the viewer can feel the three-dimensional effect). The following expressions are derived by using the expression 15 and δt:

$$\begin{matrix}[ Expression 16 ] & \\ \vert \frac{Pl - Pr}{ds} \vert \geq δ t & ( 16 ) \\ [ Expression 17 ] & \\ \vert \frac{Pl - Pr}{ds} \vert < δ t & ( 17 )\end{matrix}$$

Flattening is determined to be not caused when the expression 16 is satisfied and to be caused when the expression 17 is satisfied.

The following will describe a case of applying the allowable parallax lower limit δt to a thick object, such as a person, which is taken as an image in a short distance.

As exemplified in FIG. 17, the tip of nose of a person in a certain object distance is defined as an object i and the ear is defined as an object j.

The amount of parallax of the object i to the object j is obtained by subtracting a relative parallax amount to the object i from a relative parallax amount to the object j as well as deriving the expression 15. This is represented by the following expression:

$$\begin{matrix}[ Expression 18 ] & \\ ( α - {β}_{j} ) - ( α - {β}_{i} ) = {β}_{i} - {β}_{j} = \frac{( {Pl}_{i} - {Pr}_{i} ) - ( {Pl}_{j} - {Pr}_{j} )}{ds} & ( 18 )\end{matrix}$$

We fixed the image taking condition and the viewing condition other than the base line length 2wc, and tested using parallax images of a person. As a result, it was confirmed that the three-dimensional appearance in the face of the person was not obtained when the amount of parallax was smaller than three minutes as well as flattening. Therefore, the allowable parallax lower limit δt can be applied to the amount of parallax of not only a distant object but also the object in a short distance. That is to say, the following expressions are derived by using the expression 18 and δt:

$$\begin{matrix}[ Expression 19 ] & \\ \vert \frac{( {Pl}_{i} - {Pr}_{i} ) - ( {Pl}_{j} - {Pr}_{j} )}{ds} \vert \geq δ t & ( 19 ) \\ [ Expression 20 ] & \\ \vert \frac{( {Pl}_{i} - {Pr}_{i} ) - ( {Pl}_{j} - {Pr}_{j} )}{ds} \vert < δ t & ( 20 )\end{matrix}$$

The face of the person is determined to look three-dimensional and have the three-dimensional effect when the expression 19 is satisfied, and is determined to look flat and not have the three-dimensional effect when the expression 20 is satisfied.

In a case that an object, such as a person, satisfies the expression 20 when a three-dimensional image is taken, the image does not look three-dimensional since the amount of parallax of the person is smaller than the allowable parallax lower limit δt. In a case that a background object satisfies the expression 19 in the amount of parallax to a person not having the three-dimensional effect, the background relatively looks three-dimensional to the person since the amount of parallax of the background is larger than the allowable parallax lower limit δt. In other words, the cardboard effect is caused.

The following will assumes that an image is taken by a condition where an image taking magnification becomes less than in reality and it is determined in the expression 17 that flattening of the background is caused. At this time, objects smaller than in reality, such as a person and a car, look three-dimensional, and the image looks like the objects are surrounded by plane backgrounds. In other words, the miniature effect is caused.

As described above, the harmful effects (flattening, cardboard effect, miniature effect) in the three-dimensional image can be defined as a sensation due to brain confusion caused when an image that looks three-dimensional and an image that looks two-dimensional are mixed in one image. Therefore, the harmful effects can be related directly to a parallax in which the three-dimensional effect is obtained by evaluation amount that is of allowable parallax lower limit.

Then, in embodiments below, it is newly proposed to determine the three-dimensional appearance in parallax images by using the allowable parallax lower limit (hereinafter also referred to as “predetermined value”) in order to view a three-dimensional image without the harmful effects when the three-dimensional image is taken or viewed.

Hereinafter, a preferable embodiment of the present invention will be described in detail with reference to attached drawings.

### Embodiment 1

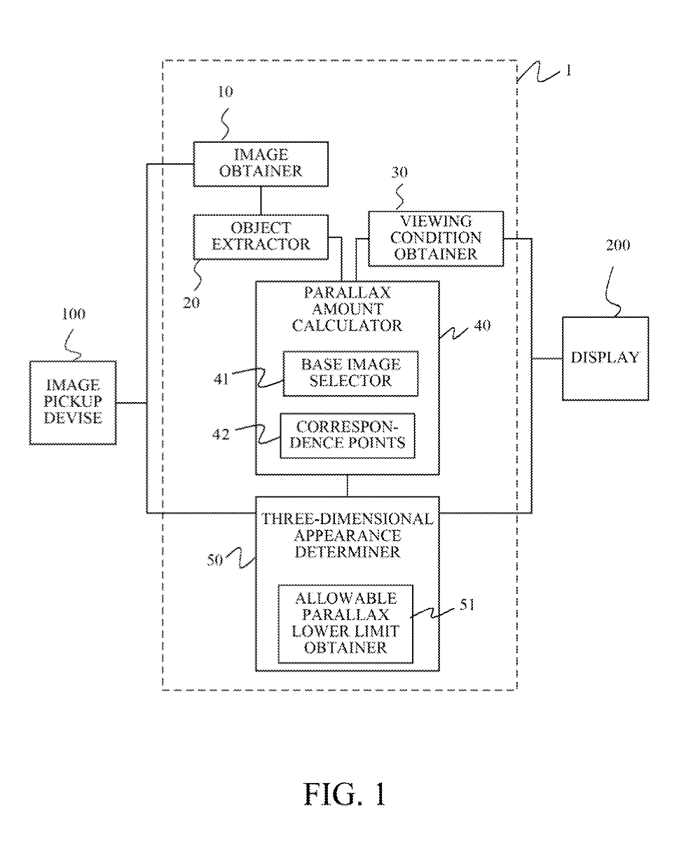

FIG. 1 is a block diagram of an image processing apparatus 1 capable of generating a three-dimensional image in embodiment 1. The image processing apparatus 1 determines, for parallax images taken from different points of view, the three-dimensional appearance in the parallax images using the allowable parallax lower limit in order to view a three-dimensional image without the harmful effects. The image pickup 100 is for example a device capable of taking right and left parallax images. The right and left parallax images respectively mean a parallax image for the left eye and a parallax image for the right eye. A display 200 is for example a device capable of displaying a three-dimensional image which a viewer can view stereoscopically on the basis of acquired right and left parallax images.

First, the configuration of the image processing apparatus 1 will be described with reference to FIG. 1. An image obtainer 10 obtains a three-dimensional image data file. The three-dimensional image data file includes for example parallax images taken by the image pickup 100, and further may include the above-mentioned parameter information on the image taking side that is added to image data. An object extractor 20 extracts a specific object in the parallax images. A viewing condition obtainer 30 obtains viewing condition information on the display 200. A parallax amount calculator 40 contains a base image selector 41 which selects one of the parallax images as a base image and a correspondence point extractor 42 which extracts correspondence points that are pixels corresponding to each other between in a parallax image as the base image and in a parallax image as a reference image. The parallax amount calculator 40 calculates the amount of parallax among a plurality of correspondence points extracted by the correspondence point extractor 42. A three-dimensional appearance determiner 50 contains an allowable parallax lower limit obtainer 51 which obtains allowable parallax lower limit information, and determines whether the three-dimensional effect to the object in the parallax images is obtained by using the above-mentioned allowable parallax lower limit.

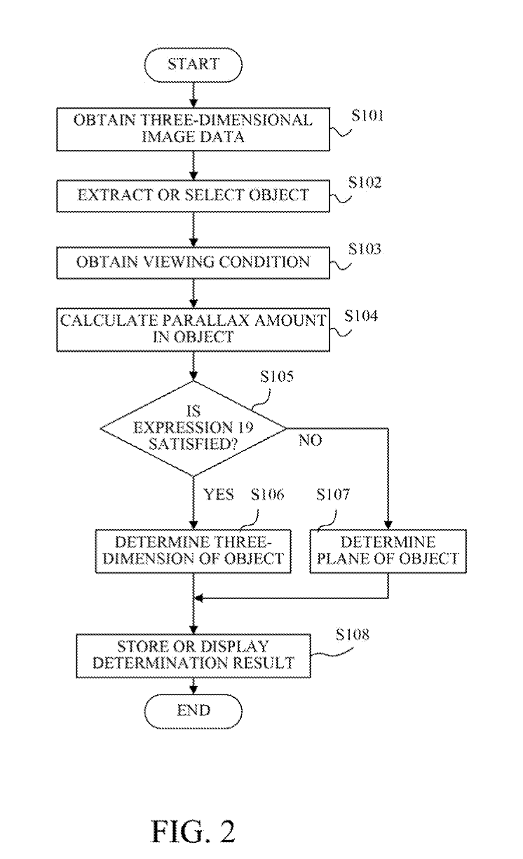

Next, a processing operation for determining the three-dimensional appearance in the image processing apparatus 1 of this embodiment will be described with reference to a flow chart in FIG. 2. First, in step S101, the image obtainer 10 obtains for example the three-dimensional image data from the image pickup 100. The method of obtaining data may be performed by a direction connection using a USB cable (not illustrated) or the like, and may be performed by a wireless connection (wireless communication) using an electric wave, an infrared ray or the like.

In step S102, the object extractor 20 extracts or selects the specific object in the parallax images included in the three-dimensional image data obtained in the previous step. As the extraction method, for example, an object area is selected by using an input interface, such as a touch panel and a button, capable of being operated by a user, and further the specific object is extracted from a specified object area on the basis of edge information or the amount of characteristic of a color or the like of the object. Moreover, the specific object may be extracted by selecting an object, such as a specific person, using a well-known facial recognition technology. Furthermore, the configuration may use a method of a template matching of registering, as the base image (template image), a part image that is cut out at an arbitrary image area and of extracting an area in which a degree of correlation to the template image is the most high in the parallax images. The template image may be registered by the user in taking an image, and it is possible to preliminarily store a plurality of representative kinds of template images into a memory or the like and to make the user to select the template image. This embodiment assumes that an object of a person surrounded with a solid line illustrated in FIG. 17 is extracted.

In step S103, the viewing condition obtainer 30 obtains the viewing condition information from for example the display 200. As described above, the viewing condition information is information on the display size and the visual distance. Further, the viewing condition information may include information on the number of display pixels or the like. The method of obtaining the viewing condition may be performed by a direction connection using a USB cable (not illustrated) or the like, and may be performed by a wireless connection using an electric wave, an infrared ray or the like. Moreover, for example, the viewing condition may be input using the above-mentioned input interface by the user, and it is possible to be configured so as to preliminarily store information on the display size and the visual distance by assuming a representative viewing environment and acquire the information.

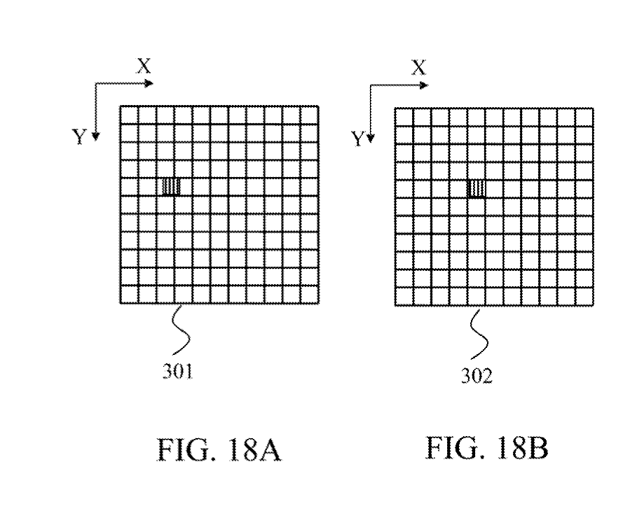

In step S104, the parallax amount calculator 40 calculates the amount of parallax in the object area extracted in step S102. First, the base image selector 41 selects one of the parallax images as a base image for calculating the amount of parallax. Next, the correspondence point extractor 42 extracts correspondence points between the parallax image as the base image and the parallax image as the reference image. The correspondence point means a pixel where the same object is reflected on the parallax images. Moreover, the correspondence points are extracted at a plurality of positions in the parallax images. The method for extracting the correspondence points will be described with reference to FIG. 18. In this case, an X-Y coordinate system set on the parallax images is used. In this coordinate system, a position of a pixel at the upper left is defined as origin in a base image 301 illustrated in FIG. 18A and in a reference image 302 illustrated in FIG. 18B, the X axis is defined as a horizontal direction and the Y axis is defined as a vertical direction. The luminance of a pixel (X,Y) on the base image 301 is defined as F1(X,Y), and the luminance of a pixel (X,Y) in the reference image 302 is defined as F2(X,Y).

A pixel (shown by hatching) on the reference image 302 corresponding to an arbitrary pixel (X,Y) (shown by hatching) on the base image 301 that is illustrated in FIG. 18A is a pixel on the reference image 302 having the most similar luminance to the luminance F1(X, Y) in the base image 301. However, it is difficult to search the most similar pixel to an arbitrary pixel in reality, and therefore a similar pixel is searched using the pixel near the coordinate (X, Y) by a method called “block matching”.

For example, a block matching processing when the size of block is 3 will be described. The luminance values of three pixels that consists of a pixel of the arbitrary coordinate (X,Y) on the basis image 301 and two pixels of the coordinates (X−1,Y), (X+1, Y) at the periphery of the arbitrary coordinate are respectively represented as F1(X, Y), F1(X−1, Y), F1(X+1, Y).

The luminance values of pixels shifted by k from the coordinate (X, Y) in the X direction on the reference image 302 are respectively represented as F2(X+k, Y), F2(X+k−1, Y), F2(X+k+1, Y).

In this case, a degree of similarity E with the pixel of the coordinate (X, Y) on the base image 301 is defined by the following expression 21:

$$\begin{matrix} [ Expression 21 ] & \\ E = [ F 1 ( X , Y ) - F 2 ( X + k , Y ) ] + [ F 1 ( X - 1 , Y ) - F 2 ( X + k - 1 , Y ) ] + [ F 1 ( X + 1 , Y ) - F 2 ( X + k + 1 , Y ) ] = {\sum }_{j = - 1}^{1} [ F 1 ( X + j , Y ) - F 2 ( X + k + j , Y ) ] & ( 21 )\end{matrix}$$

In the expression 21, the value of the degree of similarity E is sequentially calculated by changing the value of k. The (X+k, Y) at which the smallest degree of similarity E of the reference images 302 is provided is a correspondence point to the coordinate (X, Y) on the base image 301.

In addition, the correspondence points may be extracted using a method for extracting common points by the edge extraction or the like, other than the block matching.

Next, the parallax amount calculator 40 calculates the amounts of parallax (Pl−Pr) among correspondence points which are extracted at a plurality of positions. As the above-described calculation procedure, first, a parallax of taken image is calculated based on position information of an arbitrary correspondence point, and the right and left display parallaxes Pl and Pr are calculated based on display size information and the expressions 3 and 4 to calculate the amount of parallax (Pl−Pr).

In step S105 (three-dimensional determination step), the three-dimensional appearance determiner 50 determines whether the three-dimensional effect to a viewer in the object is obtained, based on the calculated amount of parallax of the object. First, the allowable parallax lower limit obtainer 51 obtains the allowable parallax lower limit information. The allowable parallax lower limit δt (prescribed value) is defined as an amount of parallax (about three minutes) where it becomes difficult for most of viewers to feel the three-dimensional effect, which is derived by our subjective assessment experiment as described above. Next, the three-dimensional appearance determiner 50 selects evaluation points in the object by defining the tip of nose as the object i (first object) and by defining the ear of the extracted object as the object j (second object), as exemplified in FIG. 17. A method of selecting the minimum and maximum parts in the calculated amount of parallax or the like also can be adopted as a method of selecting the objects i and j. The object evaluation points may be selected using the above-mentioned input interface by the user in detail. Next, the three-dimensional appearance determiner 50 determines whether to satisfy the above-mentioned expression 19 by using the allowable parallax lower limit δt, the amount of parallax at the selected evaluation point, and the visual distance that is the viewing condition obtained in the previous step. When the expression 19 is satisfied, that is, the determination is “YES” (equal to or more than a prescribed value), the object extracted as described above can make the viewer feel the three-dimensional effect, and therefore the object is determined as three-dimension (3D) in step S106. In contrast, the expression 19 is not satisfied, that is, the determination is “NO” (less than a prescribed value), the object extracted as described above cannot make the viewer feel the three-dimensional effect, and therefore the object is determined as two-dimension (2D) in step S107.

In step S108, the determination result determined in the previous step is stored in the image data file. The determination result may be displayed on the display 200, and may be stored in the storage medium (not illustrated) or the like separately.

While the three-dimensional appearance is determined using the expression 19 in step S105, the allowable parallax lower limit δt is the amount of statistics on the basis of the subjective assessment and might provides a little difference result to some viewers. Therefore, it is preferable that the following expression 22 that uses a correction term C is used.

$$\begin{matrix}[ Expression 22 ] & \\ \vert \frac{( {Pl}_{i} - {Pr}_{i} ) - ( {Pl}_{j} - {Pr}_{j} )}{ds} \vert \geq C \cdot δ t & ( 22 )\end{matrix}$$

The value stored as an initial condition in a memory (not illustrated) may be used as the correction term C, and the user may input the correction term C using the above-mentioned interface by the user.

As described above, it is possible to determine whether the above-mentioned harmful effect (flattening, cardboard effect, and miniature effect) is caused in the three-dimensional image by determining the three-dimensional appearance of the extracted object in the parallax images. Therefore, it becomes possible to easily perform an effective determination of the image-taking and the display of the three-dimensional image, and a high quality display of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S101 to S103 shown in the flow can be changed in many ways.

### Embodiment 2

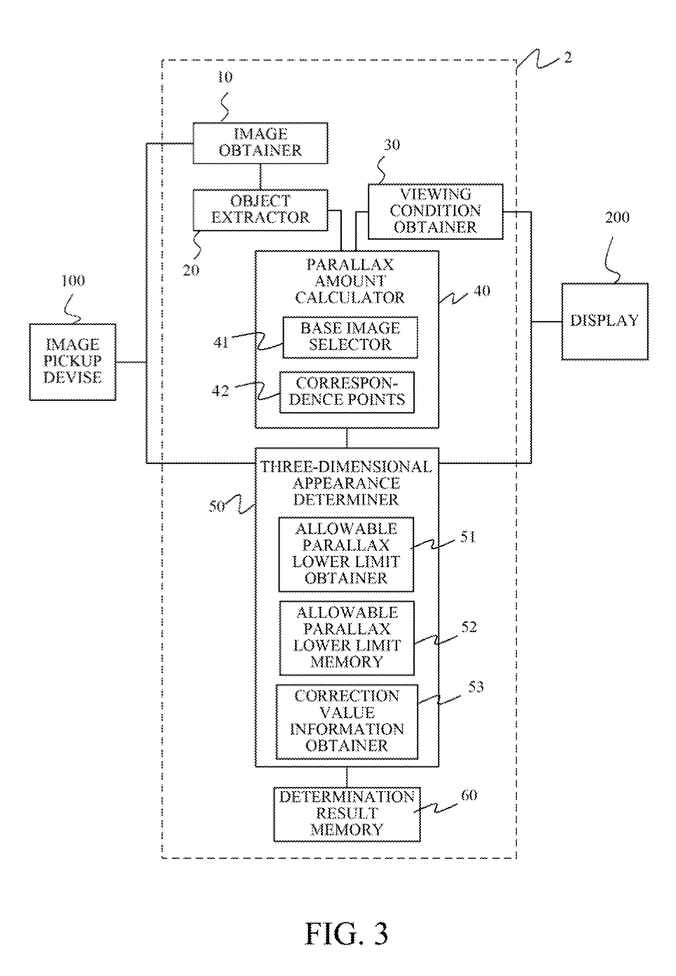

FIG. 3 is a block diagram of an image processing apparatus 2 in embodiment 2. The explanation that overlaps with embodiment 1 is omitted. The image processing apparatus 2 determines, for parallax images taken from different points of view, the three-dimensional appearance in the parallax images using the allowable parallax lower limit in order to view a three-dimensional image without the harmful effects.

The configuration of the image processing apparatus 2 will be described with reference to FIG. 3. Differences from embodiment 1 are an internal configuration of the three-dimensional appearance determiner 50 and that a determination result memory 60 is further added. The three-dimensional appearance determiner 50 contains an allowable parallax lower limit obtainer 51 that obtains allowable parallax lower limit information and an allowable parallax lower limit memory 52 where the allowable parallax lower limit information is stored. The three-dimensional appearance determiner 50 further contains a correction value information obtainer 53 which obtains information on the above-mentioned correction term C of the allowable parallax lower limit in order to adapt to the individual difference in the viewer, and determines whether the three-dimensional effect to the object in the parallax images is obtained by using the allowable parallax lower limit. The determination result memory 60 stores the determination result into the image data file.

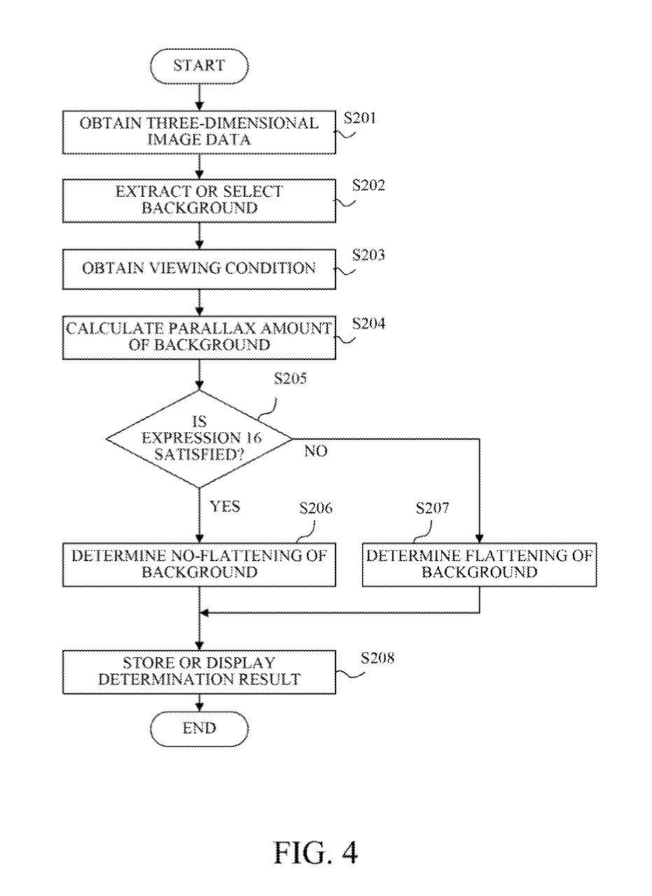

Next, a processing operation for determining the three-dimensional appearance in the image processing apparatus of this embodiment will be described with reference to a flow chart in FIG. 4. First, in step S201, the image obtainer 10 obtains for example the three-dimensional image data from the image pickup 100. The method of obtaining data may be performed by a direction connection using a USB cable (not illustrated) or the like, and may be performed by a wireless connection (wireless communication) using an electric wave, an infrared ray or the like.

In step S202, the object extractor 20 extracts or selects a background object (and an object at infinity) in the parallax images included in the three-dimensional image data obtained in the previous step. As the extraction method, for example an object area is selected by using for example an input interface, such as a touch panel and a button, capable of being operated by a user, and further a specific object is extracted from a specified object area on the basis of edge information or the amount of characteristic of a color or the like of the object. Furthermore, the configuration may use a method of a template matching of registering, as the base image (template image), a part image that is cut out at an arbitrary image area and of extracting an area in which a degree of correlation to the template image is the most high in the parallax images. The template image may be registered by the user in taking an image, and it is possible to preliminarily store a plurality of representative kinds of template images into a memory or the like and make the user to select the template image. This embodiment assumes that a background object βk (mountain) surrounded with a broken line illustrated in FIG. 17 is extracted.

In step S203, the viewing condition obtainer 30 obtains viewing condition information from for example the display 200. As described above, the viewing condition information is information on the display size and the visual distance. Further, the viewing condition information may include information on the number of display pixels or the like. The method of obtaining the viewing condition may be performed by a direction connection using a USB cable (not illustrated) or the like, and may be performed by a wireless connection using an electric wave, an infrared ray or the like. Moreover, for example, the viewing condition may be input using the above-mentioned input interface by the user, and it is possible to be configured so as to preliminarily store information on the display size and the visual distance by assuming a representative viewing environment and acquire the information.

In step S204, the parallax amount calculator 40 calculates the amount of parallax of the background object (and object at infinity) which is extracted in step S202. First, the base image selector 41 selects one of the parallax images as a base image for calculating the amount of parallax. Next, the correspondence point extractor 42 extracts correspondence points between the parallax image as the base image and the parallax image as the reference image. The correspondence point means a pixel where the same object is reflected on the parallax images. Moreover, the correspondence points are extracted at a plurality of positions in the parallax images. Next, the parallax amount calculator 40 calculates the amounts of parallax (Pl−Pr) among correspondence points which are extracted at a plurality of positions. As the above described calculation procedure, first, a parallax of a taken image is calculated based on position information of an arbitrary correspondence point, and the right and left display parallaxes Pl and Pr are calculated based on display size information and the expressions 3 and 4 to calculate the amount of parallax (Pl−Pr).

In step S205 (three-dimensional determination step), the three-dimensional appearance determiner 50 determines whether the three-dimensional effect to a viewer in the background object is objected, based on the calculated amount of parallax of the background object. First, the allowable parallax lower limit obtainer 51 obtains the allowable parallax lower limit information from the allowable parallax lower limit memory 52. The allowable parallax lower limit δt (prescribed value) is defined as an amount of parallax (about three minutes) where it becomes difficult for most of viewers to feel the three-dimensional effect, which is derived by our subjective assessment experiment as described above. Next, the three-dimensional appearance determiner 50 determines whether to satisfy the above-mentioned expression 16 by using the allowable parallax lower limit δt, the amount of parallax of the extracted background object, and the visual distance that is the viewing condition obtained in the previous step. When the expression 16 is satisfied, that is, the determination is “YES”, the background object extracted as described above can make the viewer feel the three-dimensional effect to the object at infinity, and therefore the background object is determined as not flattening in step S206. In contrast, the expression 16 is not satisfied, that is, the determination is “NO”, the background object extracted as described above cannot make the viewer feel the three-dimensional effect to the object at infinity, and therefore the background object is determined as flattening in step S207.

In step S208, the determination result memory 60 stores the determination result determined in the previous step into the image data file. The determination result may be displayed on the display 200, and may be stored in the storage medium (not illustrated) or the like separately.

While the three-dimensional appearance is determined using the expression 16 in step S205, the allowable parallax lower limit δt is the amount of statistics on the basis of the subjective assessment and might provides a little difference result to some viewers. Therefore, it is preferable that the following expression 23 that uses a correction term C obtained by the correction value information obtainer 53 is used.

$$\begin{matrix}[ Expression 23 ] & \\ \vert \frac{Pl - Pr}{ds} \vert \geq C \cdot δ t & ( 23 )\end{matrix}$$

The value stored as an initial condition in a memory (not illustrated) may be used as the correction term C, and the user may input the correction term C using the above-mentioned interface.

As described above, it is possible to determine whether the above-mentioned harmful effect (flattening) is caused in the three-dimensional image by determining the three-dimensional appearance of the background object (first object) in the parallax images to the object at infinity (second object). Therefore, it becomes possible to easily perform an effective determination of the image-taking and the display of the three-dimensional image, and a high quality display of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S201 to S203 shown in the flow can be changed in many ways.

### Embodiment 3

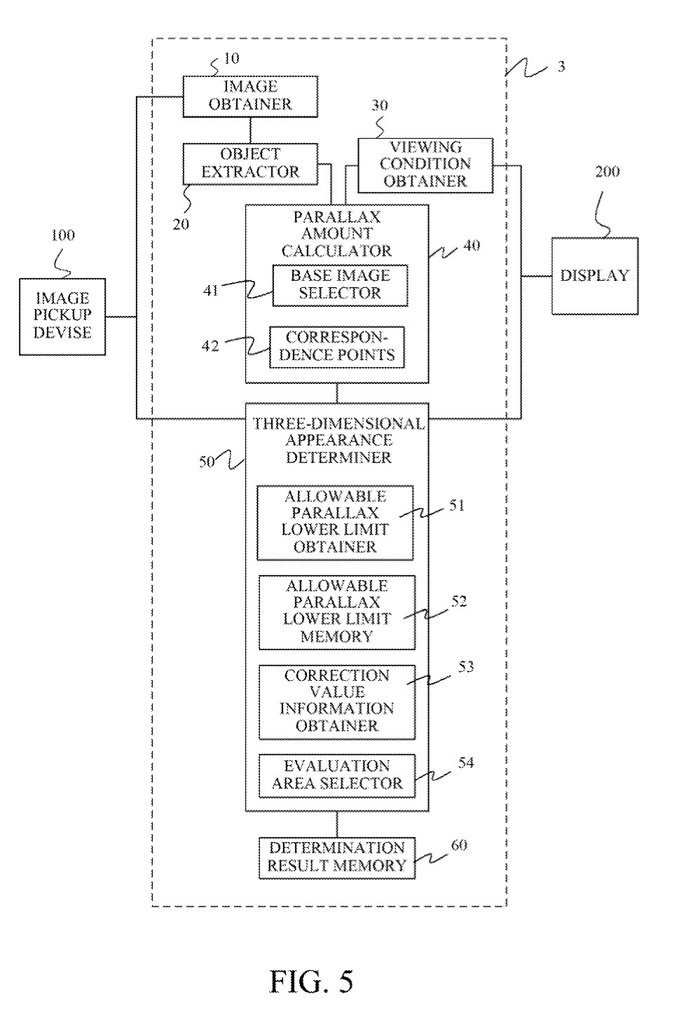

FIG. 5 is a block diagram of an image processing apparatus 3 in embodiment 3. The explanation that overlaps with embodiment 1 is omitted. The image processing apparatus 3 determines, for parallax images taken from different points of view, the three-dimensional appearance in the parallax images using the allowable parallax lower limit in order to view a three-dimensional image without the harmful effects.

The configuration of the image processing apparatus 3 will be described with reference to FIG. 5. Differences from embodiment 1 are an internal configuration of the three-dimensional appearance determiner 50 and that the determination result memory 60 is further added. The three-dimensional appearance determiner 50 contains an allowable parallax lower limit obtainer 51 that obtains allowable parallax lower limit information and an allowable parallax lower limit memory 52 where the allowable parallax lower limit information is stored. The three-dimensional appearance determiner 50 further contains a correction value information obtainer 53 which obtains information on the above-mentioned correction term C of the allowable parallax lower limit in order to adapt to the individual difference in the viewer. Further, the three-dimensional appearance determiner 50 contains an evaluation area selector 54 which selects an area where a three-dimensional appearance is determined in the extracted object, and determines whether the three-dimensional effect to the object in the parallax images is obtained by using the allowable parallax lower limit. The determination result memory 60 stores the determination result into the image data file.

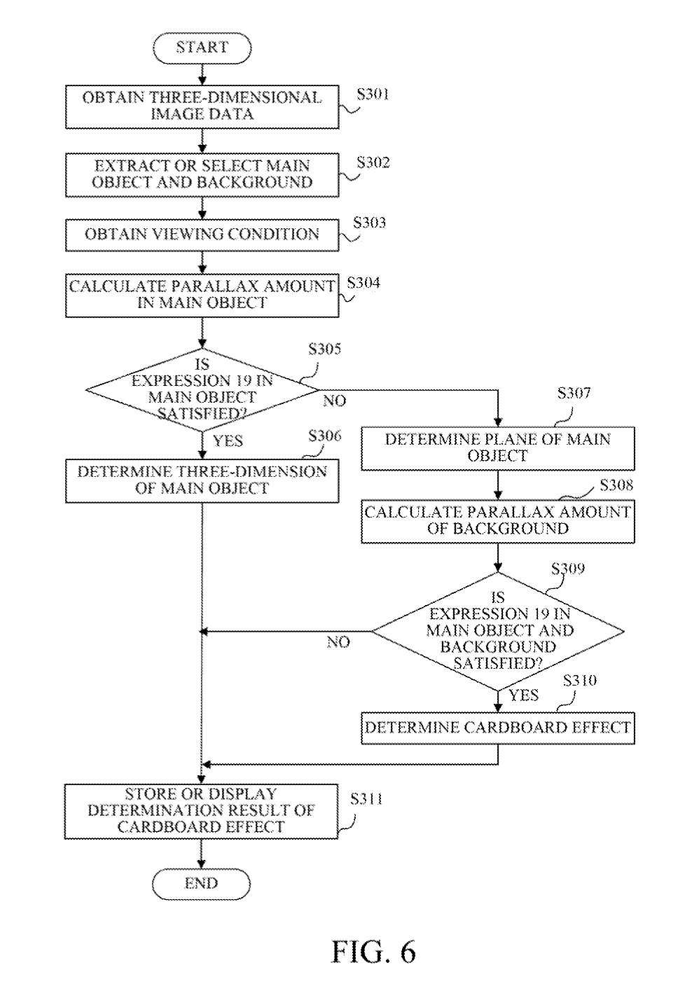

Next, a processing operation for determining the three-dimensional appearance in the image processing apparatus of this embodiment will be described with reference to a flow chart in FIG. 6. First, in step S301, the image obtainer 10 obtains for example the three-dimensional image data from the image pickup 100. The method of obtaining data may be performed by a direction connection using a USB cable (not illustrated) or the like, and may be performed by a wireless connection (wireless communication) using an electric wave, an infrared ray or the like.

In step S302, the object extractor 20 extracts or selects a main object and a background object in the parallax images included in the three-dimensional image data obtained in the previous step. As the extraction method, for example an object area is selected by using for example an input interface, such as a touch panel and a button, capable of being operated by a user, and further a specific object is extracted from a specified object area on the basis of edge information or the amount of characteristic of a color or the like of the object. Moreover, the specific object may be extracted by selecting an object, such as a specific person, using a well-known facial recognition technology. Furthermore, the configuration may use a method of a template matching of registering, as the base image (template image), a part image that is cut out at an arbitrary image area and of extracting an area in which a degree of correlation to the template image is the most high in the parallax images. The template image may be registered by the user in taking an image, and it is possible to preliminarily store a plurality of representative kinds of template images into a memory or the like and make the user to select the template image. This embodiment assumes that a person surrounded with the solid line illustrated in FIG. 17 is extracted as the main object, and a mountain surrounded with the broken line is extracted as the background object.

In step S303, the viewing condition obtainer 30 obtains viewing condition information from for example the display 200. As described above, the viewing condition information is information on the display size and the visual distance. Further, the viewing condition information may include information on the number of display pixels or the like. The method of obtaining the viewing condition may be performed by a direction connection using a USB cable (not illustrated) or the like, and may be performed by a wireless connection using an electric wave, an infrared ray or the like. Moreover, for example, the viewing condition may be input using the above-mentioned input interface by the user, and it is possible to be configured so as to preliminarily store information on the display size and the visual distance by assuming a representative viewing environment and acquire the information.

In step S304, the parallax amount calculator 40 calculates the amount of parallax of the main object which is extracted in step S302. First, the base image selector 41 selects one of the parallax images as a base image for calculating the amount of parallax. Next, the correspondence point extractor 42 extracts correspondence points between the parallax image as the base image and the parallax image as the reference image. The correspondence point means a pixel where the same object is reflected on the parallax images. Moreover, the correspondence points are extracted at a plurality of positions in the parallax images. Next, the parallax amount calculator 40 calculates the amounts of parallax (Pl−Pr) among correspondence points which are extracted at a plurality of positions. As the above described calculation procedure, first, a parallax of a taken image is calculated based on position information of an arbitrary correspondence point, and the right and left display parallaxes Pl and Pr are calculated based on display size information and the expressions 3 and 4 to calculate the amount of parallax (Pl−Pr).

In step S305 (first three-dimensional determination step), the three-dimensional appearance determiner 50 determines whether the three-dimensional effect to a viewer in the main object is objected, based on the calculated amount of parallax of the main object. First, the allowable parallax lower limit obtainer 51 obtains the allowable parallax lower limit information from the allowable parallax lower limit memory 52. The allowable parallax lower limit δt (prescribed value) is defined as an amount of parallax (about three minutes) where it becomes difficult for most of viewers to feel the three-dimensional effect, which is derived by our subjective assessment experiment as described above. Next, the evaluation area selector 54 selects an evaluation area in the main object by defining the tip of nose as the object i and by defining the ear of the extracted main object as the object j, as exemplified in FIG. 17. A method of selecting the minimum and maximum parts in the calculated amount of parallax or the like can be adopted as a method of selecting the objects i and j. Moreover, the object evaluation area may be selected using the above-mentioned input interface by the user in detail. Next, the three-dimensional appearance determiner 50 determines whether to satisfy the above-mentioned expression 19 by using the allowable parallax lower limit δt, the amount of parallax at the selected evaluation area, and the visual distance that is the viewing condition obtained in the previous step. When the expression 19 is satisfied, that is, the determination is “YES”, the main object extracted as described above can make the viewer feel the three-dimensional effect, and therefore the main object is determined as three-dimension (3D) in step S306. In contrast, the expression 19 is not satisfied, that is, the determination is “NO”, the main object extracted as described above cannot make the viewer feel the three-dimensional effect, and therefore the main object is determined as plane (2D) in step S307.

In step S308, the parallax amount calculator 40 calculates the amount of parallax to the extracted background object in step S302 when the main object is determined as plane in step S307.

In step S309 (second three-dimensional determination step), the three-dimensional appearance determiner 50 determines whether a relative three-dimensional appearance of the background object to the main object is obtained, based on the amount of parallax of the background object and the amount of parallax of the main object which are calculated. First, the allowable parallax lower limit obtainer 51 obtains the allowable parallax lower limit information from the allowable parallax lower limit memory 52. Next, the evaluation area selector 54 selects an evaluation area in the parallax image by defining the tip of nose of the extracted main object as the object (first object) and by defining the mount of the background object as the object k (second object), as exemplified in FIG. 17. Next, the three-dimensional appearance determiner 50 determines whether to satisfy the above-mentioned expression 19 by using the allowable parallax lower limit δt, the amount of parallax of the selected evaluation area, and the visual distance that is the viewing condition obtained in the previous step. When the expression 19 is satisfied, that is, the determination is “YES”, the background object extracted as described above can make the viewer feel the relative three-dimensional effect to the main object, and therefore it is determined that the cardboard effect is caused in step S310. In contrast, the expression 19 is not satisfied, that is, the determination is “NO”, the background object extracted as described above cannot make the viewer feel the relative three-dimensional effect to the main object, and therefore it is determined that the cardboard effect is not caused.

In step S311, the determination result memory 60 stores the determination result determined in the previous step into the image data file. The determination result may be displayed on the display 200, and may be stored in the storage medium (not illustrated) or the like separately.

While the three-dimensional appearance is determined using the expression 19 in steps S305 and S309, the allowable parallax lower limit δt is the amount of statistics on the basis of the subjective assessment and might provides a little difference result to some viewers. Therefore, it is preferable that the expression 22 that uses a correction term C obtained by the correction value information obtainer 53 is used.

As described above, it is possible to determine whether the above-mentioned harmful effect (cardboard effect) is caused in the three-dimensional image by determining the three-dimensional appearance of the main objet and the relative three-dimensional appearance of the background object to the main object in the parallax images. Therefore, it becomes possible to easily perform an effective determination of the image-taking and the display of the three-dimensional image, and a high quality display of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S301 to S303 shown in the flow can be changed in many ways.

### Embodiment 4

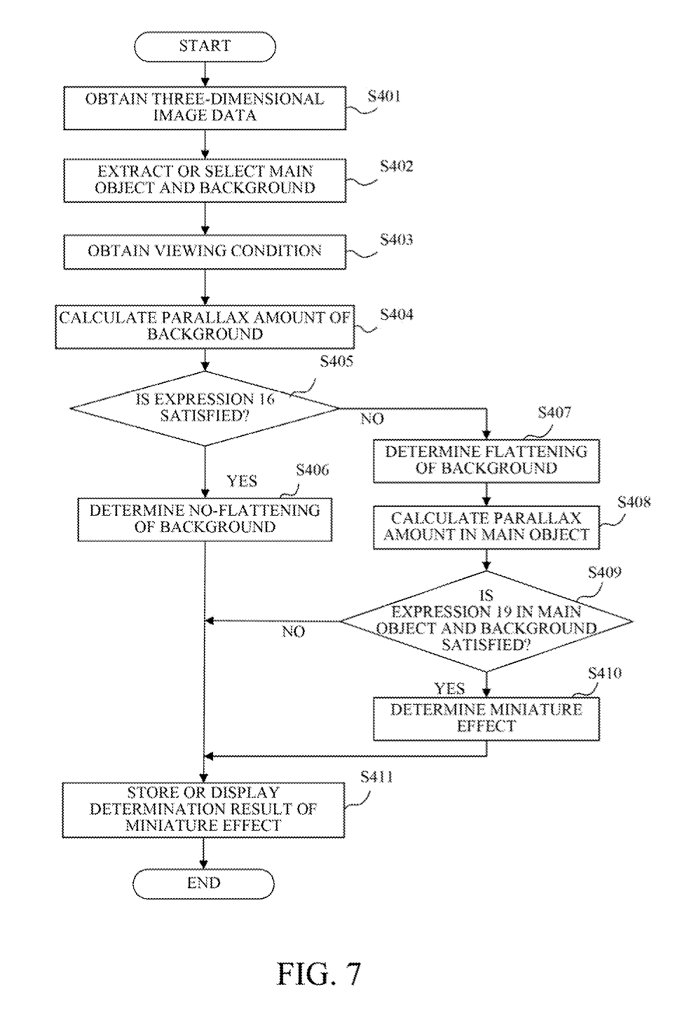

FIG. 7 is a flow chart of a processing operation of determining a three-dimensional appearance in an image processing apparatus of embodiment 4. In addition, the explanation of the image processing apparatus is omitted because the image processing apparatus of embodiment 4 has the same configuration as the image processing apparatus of embodiment 3.

A processing operation for determining the three-dimensional appearance in the image processing apparatus of this embodiment will be described with reference to a flow chart in FIG. 7. First, in step S401, the image obtainer 10 obtains for example the three-dimensional image data from the image pickup 100. The method of obtaining data may be performed by a direction connection using a USB cable (not illustrated) or the like, and may be performed by a wireless connection (wireless communication) using an electric wave, an infrared ray or the like.

In step S402, the object extractor 20 extracts or selects a main object and a background object (and an object at infinity) in the parallax images included in the three-dimensional image data obtained in the previous step. As the extraction method, for example an object area is selected by using for example an input interface, such as a touch panel and a button, capable of being operated by a user, and further a specific object is extracted from a specified object area on the basis of edge information or the amount of characteristic of a color or the like of the object. Moreover, the specific object may be extracted by selecting an object, such as a specific person, using a well-known facial recognition technology. Furthermore, the configuration may use a method of a template matching of registering, as the base image (template image), a part image that is cut out at an arbitrary image area and of extracting an area in which a degree of correlation to the template image is the most high in the parallax images. The template image may be registered by the user in taking an image, and it is possible to preliminarily store a plurality of representative kinds of template images into a memory or the like and make the user to select the template image. This embodiment assumes that a person surrounded with the solid line illustrated in FIG. 17 is extracted as the main object, and a mountain surrounded with the broken line is extracted as the background object.

In step S403, the viewing condition obtainer 30 obtains viewing condition information from for example the display 200. As described above, the viewing condition information is information on the display size and the visual distance. Further, the viewing condition information may include information on the number of display pixels or the like. The method of obtaining the viewing condition may be performed by a direction connection using a USB cable (not illustrated) or the like, and may be performed by a wireless connection using an electric wave, an infrared ray or the like. Moreover, for example, the viewing condition may be input using the above-mentioned input interface by the user, and it is possible to be configured so as to preliminarily store information on the display size and the visual distance by assuming a representative viewing environment and acquire the information.

In step S404, the parallax amount calculator 40 calculates the amount of parallax of the background object (and object at infinity) which is extracted in step S402. First, the base image selector 41 selects one of the parallax images as a base image for calculating the amount of parallax. Next, the correspondence point extractor 42 extracts correspondence points between the parallax image as the base image and the parallax image as the reference image. The correspondence point means a pixel where the same object is reflected on the parallax images. Moreover, the correspondence points are extracted at a plurality of positions in the parallax images. Next, the parallax amount calculator 40 calculates the amounts of parallax (Pl−Pr) among correspondence points which are extracted at a plurality of positions. As the above described calculation procedure, first, a parallax of a taken image is calculated based on position information of an arbitrary correspondence point, and the right and left display parallaxes Pl and Pr are calculated based on display size information and the expressions 3 and 4 to calculate the amount of parallax (Pl−Pr).

In step S405 (first three-dimensional determination step), the three-dimensional appearance determiner 50 determines whether the three-dimensional effect to a viewer in the background object is objected, based on the calculated amount of parallax of the background object. First, the allowable parallax lower limit obtainer 51 obtains the allowable parallax lower limit information from the allowable parallax lower limit memory 52. The allowable parallax lower limit δt (prescribed value) is defined as an amount of parallax (about three minutes) where it becomes difficult for most of viewers to feel the three-dimensional effect, which is derived by our subjective assessment experiment as described above. Next, the three-dimensional appearance determiner 50 determines whether to satisfy the above-mentioned expression 16 by using the allowable parallax lower limit δt, the amount of parallax at the extracted background object, and the visual distance that is the viewing condition obtained in the previous step. When the expression 16 is satisfied, that is, the determination is “YES”, the background object extracted as described above can make the viewer feel the three-dimensional effect to the object at infinity, and therefore the background object is determined as not flattening in step S406. In contrast, the expression 16 is not satisfied, that is, the determination is “NO”, the background object extracted as described above cannot make the viewer feel the three-dimensional effect to the object at infinity, and therefore the background object is determined as flattening in step S407.

In step S408, the parallax amount calculator 40 calculates the amount of parallax to the extracted main object in step S402 when the background object is determined as plane in step S407.

In step S409 (second three-dimensional determination step), the three-dimensional appearance determiner 50 determines whether a relative three-dimensional appearance of the main object to the background object is obtained, based on the amount of parallax of the background object and the amount of parallax of the main object which are calculated. First, the allowable parallax lower limit obtainer 51 obtains the allowable parallax lower limit information from the allowable parallax lower limit memory 52. Next, the evaluation area selector 54 selects an evaluation area in the parallax image by defining the tip of nose of the extracted main object as the object i (first object) and by defining the mount of the background object as the object k (second object), as exemplified in FIG. 17. Next, the three-dimensional appearance determiner 50 determines whether to satisfy the above-mentioned expression 19 by using the allowable parallax lower limit δt, the amount of parallax of the selected evaluation area, and the visual distance that is the viewing condition obtained in the previous step. When the expression 19 is satisfied, that is, the determination is “YES”, the main object extracted as described above can make the viewer feel the relative three-dimensional effect to the background object, and therefore it is determined that the miniature effect is caused in step S410. In contrast, the expression 19 is not satisfied, that is, the determination is “NO”, the main object extracted as described above cannot make the viewer feel the relative three-dimensional effect to the background object, and therefore it is determined that the miniature effect is not caused.

In step S411, the determination result memory 60 stores the determination result determined in the previous step into the image data file. The determination result may be displayed on the display 200, and may be stored in the storage medium (not illustrated) or the like separately.

While the three-dimensional appearance is determined using the expressions 16 and 19 in steps S405 and S409, the allowable parallax lower limit δt is the amount of statistics on the basis of the subjective assessment and might provides a little difference result to some viewers. Therefore, it is preferable that the expressions 22 and 23 that use a correction term C obtained by the correction value information obtainer 53 is used.

As described above, it is possible to determine whether the above-mentioned harmful effect (miniature effect) is caused in the three-dimensional image by determining the three-dimensional appearance of the background objet and the relative three-dimensional appearance of the main object to the background object in the parallax images. Therefore, it becomes possible to easily perform an effective determination of the image-taking and the display of the three-dimensional image, and a high quality display of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S401 to S403 shown in the flow can be changed in many ways.

### Embodiment 5

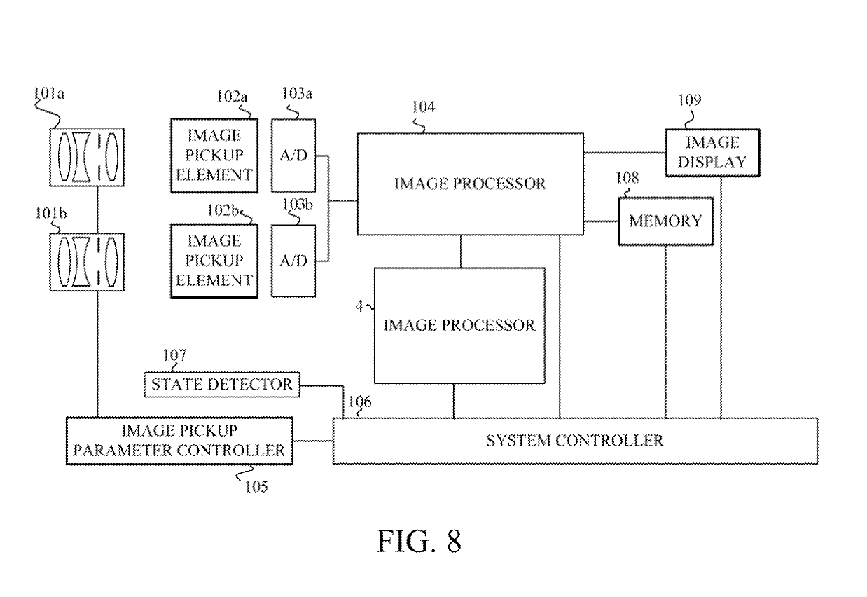

FIG. 8 is an image pickup apparatus capable of obtaining and generating a three-dimensional image in embodiment 5. The image pickup apparatus obtains parallax images taken from different points of view, and determines the three-dimensional appearance of an object in the taken parallax images using the allowable parallax lower limit in order to realize a three-dimensional image without the harmful effects. A reference numeral 101a denotes an image pickup optical system for the right parallax image, and a reference numeral 101b denotes an image pickup optical system for the lift parallax image. While it is preferred that the distance between the optical axes of the right and left image pickup optical systems 101a and 101b, that is to say, based length, is about 65 mm, but the distance may be changed depending on the request of the three-dimensional appearance to the displayed three-dimensional image. Each of the right and left image pickup elements 102a and 102b converts, into an electrical signal, an object image (optical image) formed by the right and left image pickup optical systems. A/D convertors 103a and 103b convert, into a digital signal, an analog output signal that is output from the image pickup element, and supply it to an image processor 104. The image processor 104 generates the right and left parallax images as the image data by executing an image processing, such as a pixel interpolation processing and a color conversion processing, to a digital signal that is output from the A/D convertors. The image processor 104 calculates information on object luminance or a focus state (contrast state) of the image pickup optical system on the basis of the parallax images, and supplies the calculation result to a system controller 106. The operation of the image processor 104 is controlled by the system controller 106.

A state detector 107 detects an image pickup state, such as an aperture diameter of a diaphragm and a focus lens (not illustrated), in the image pickup optical systems 101a and 101b, and supplies the detection data to the system controller 106. The system controller 106 controls an image pickup parameter controller 105 on the basis of the calculation result from the image processor 104 and image pickup state information from the state detector 107, thereby changing the aperture diameter of the diaphragm or moving the focus lens. As a result, an automatic exposure control or an autofocus can be performed. The system controller 106 is configured by a CPU, a MPU, or the like, and controls the whole of the image pickup apparatus.

A memory 108 stores the right and left parallax images that are generated by the image processor 104. Moreover, a file header of a image file including the right and left parallax images is stored.

An image display 109 is configured by for example a liquid display element and a lenticular lens, and shows an three-dimensional image by guiding the right and left parallax images into the right and left eyes of the viewer separately by an optical effect of the lenticular lens.

Since an image processor 4 has the same configuration as the image processing apparatus 1 of embodiment 1, the explanation thereof is omitted. Although the following description assumes the same configuration as the image processing apparatus 1, the configurations in embodiments 2-4 may be naturally used.

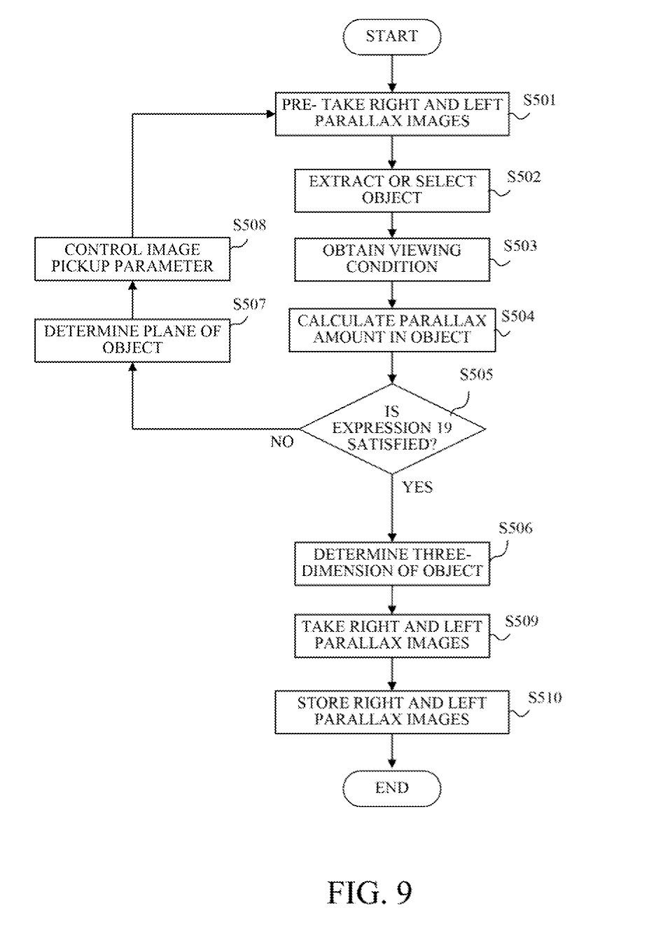

The processing operation of the image pickup apparatus in this embodiment will be described with reference to a flow chart in FIG. 9. The system controller 106 in step S501 controls the image pickup optical systems 101a and 101b via the image pickup parameter controller 105 on the basis of a state of the image pickup optical system that the photographer desires when the image pickup signal from a user is input. For example, the image pickup signal from the user means a signal that is input by half pushing a release switch (not illustrated). Next, the system controller 106 causes the image pickup elements 102a and 102b to photoelectrically convert the object image formed by each of the image optical systems 101a and 101b. The system controller 106 causes the outputs from the image pickup elements 102a and 102b to be transferred to the image pickup processor 104 via the A/D convertor 103a and 103b, and causes the image processor 104 to generate right and left pre-parallax images. The generated pre-parallax image is obtained by the image obtainer 10 included in the image processor 4 having the same configuration as the image processing apparatus 1 as illustrated in FIG. 1.

In step S502, the object extractor 20 extracts or selects a specific object in the pre-parallax images. This embodiment assumes that a person object surrounded with the solid line illustrated in FIG. 17 is extracted as the background object.

In step S503, the viewing condition obtainer 30 obtains viewing condition information. As described above, the viewing condition information is information on the display size and the visual distance. Further, the information may include information on the number of display pixels or the like. Moreover, for example, the viewing condition may be input using the above-mentioned input interface by the user, and it is possible to be configured so as to preliminarily store information on the display size and the visual distance by assuming a representative viewing environment and acquire the information.

In step S504, the parallax amount calculator 40 calculates the amount of parallax in the object area which is extracted in step S502. First, the base image selector 41 selects one of the parallax images as a base image for calculating the amount of parallax. Next, the correspondence point extractor 42 extracts correspondence points between the parallax image as the base image and the parallax image as the reference image. Next, the parallax amount calculator 40 calculates the amounts of parallax (Pl−Pr) among correspondence points which are extracted.

In step S505 (three-dimensional determination step), the three-dimensional appearance determiner 50 determines whether the three-dimensional effect to a viewer in the object is objected, based on the calculated amount of parallax of the object. First, the allowable parallax lower limit obtainer 51 obtains the allowable parallax lower limit information. Next, the three-dimensional determiner 50 selects an evaluation point in the object by defining the tip of nose as the object i and by defining the ear of the extracted object as the object j, as exemplified in FIG. 17. Next, the three-dimensional appearance determiner 50 determines whether to satisfy the above-mentioned expression 19 by using the allowable parallax lower limit δt, the amount of parallax at the selected evaluation point, and the visual distance that is the viewing condition obtained in the previous step. When the expression 19 is satisfied, that is, the determination is “YES”, the object extracted as described above can make the viewer feel the three-dimensional effect, and therefore the object is determined as three-dimension (3D) in step S506. In contrast, the expression 19 is not satisfied, that is, the determination is “NO”, the object extracted as described above cannot make the viewer feel the three-dimensional effect, and therefore the object is determined as plane (2D) in step S507.

In step S508, when the object is determined as plane in step S507, the system controller 106 controls the image pickup optical systems 101a and 101b via the image pickup parameter controller 105 (image pickup apparatus controller) on the basis of the determination result in step S507. The image pickup parameters controlled in this embodiment are a focal length of each image pickup optical system and a base length that is the distance between the optical axes of both image pickup optical systems, which are the image pickup conditions of influencing the three-dimensional appearance. When the object is determined as plane, the three-dimensional appearance of the object can be improved by extending the focal length to the telephoto end (by causing the angle of view to be narrowed). Further, the three-dimensional appearance of the object also can be improved by changing the base length so that the distance between the optical axes extends. The processing returns to step S501 again by using the image pickup parameters controlled in step S508, and the pre-image taking of the right and left parallax images is started.

When the object is finally determined as a three-dimension in step S506, a full-pushing of a release switch (not illustrated) becomes possible in step S509, and a final image taking of the right and left parallax images is performed.

In step S510, the parallax image taken in step S509 is stored into an image data file. The image taking result may be displayed on the image display 109, and also may be stored in a storage medium (not illustrated) or the like separately.

It is also possible to provide a determination cancel mechanism or the like that is capable of forcibly transferring the processing to step S509 by the determination of the user to perform the final image taking when the object is determined as plane in step S507. In this case, it is preferred that the taken image is viewed as 2D image because the object cannot be viewed as three-dimension.

As described above, it is possible to determine whether the above-mentioned harmful effect (flattening, cardboard effect, miniature effect) is caused in the three-dimensional image by determining the three-dimensional appearance of the objet in the parallax images. Therefore, it becomes possible to easily perform an effective determination of the image-taking of the three-dimensional image, and a high quality image-taking of the three-dimensional image can be realized

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S501 to S503 shown in the flow can be changed in many ways.

### Embodiment 6

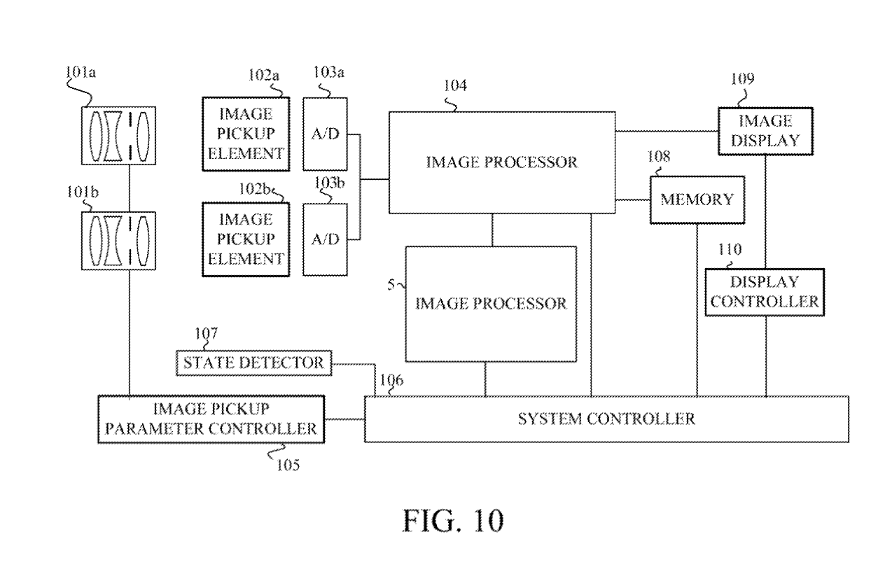

FIG. 10 is a block diagram of an image pickup apparatus in embodiment 6. The explanation that overlaps with embodiment 5 is omitted. A difference from embodiment 5 is that a display controller 110 is further added. The display controller 110 controls contents displayed on the image display 109.

Since an image processor 5 has the same configuration as the image processing apparatus 1 in embodiment 1, the explanation thereof is omitted. Although the following description assumes the same configuration as the image processing apparatus 1, the configurations in embodiments 2-4 may be naturally used.

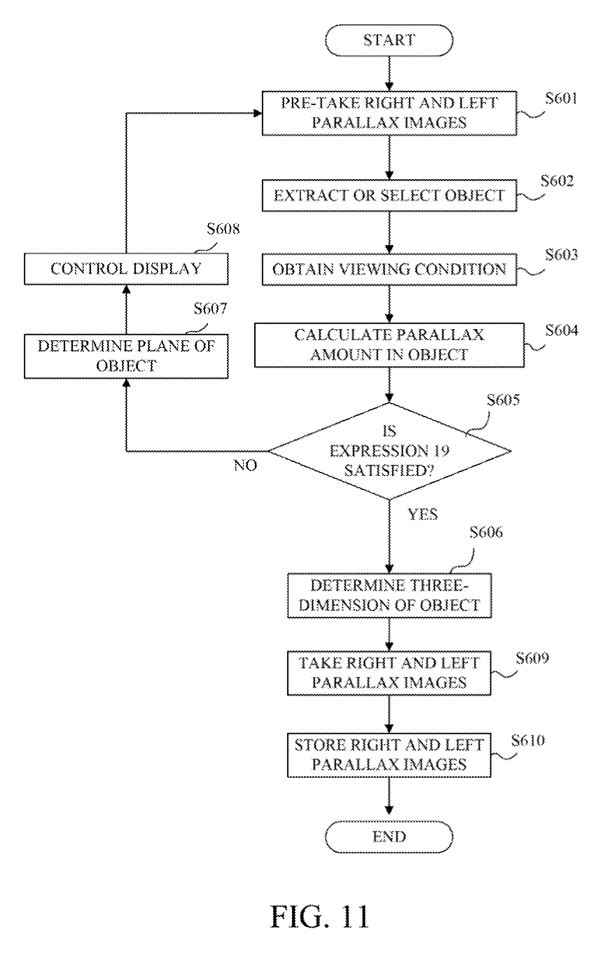

The processing operation of the image pickup apparatus in this embodiment will be described with reference to a flow chart in FIG. 11. The system controller 106 in step S601 controls the image pickup optical systems 101a and 101b via the image pickup parameter controller 105 on the basis of a state of the image pickup optical system that the photographer desires when the image pickup signal from a user is input. For example, the image pickup signal from the user means a signal that is input by half pushing a release switch (not illustrated). Next, the system controller 106 causes the image pickup elements 102a and 102b to photoelectrically convert the object image formed by each of the image optical systems 101a and 101b. The system controller 106 causes the outputs from the image pickup elements 102a and 102b to be transferred to the image pickup processor 104 via the A/D convertor 103a and 103b, and causes the image processor 104 to generate right and left pre-parallax images. The generated pre-parallax image is obtained by the image obtainer 10 included in the image processor 5 having the same configuration as the image processing apparatus 1 as illustrated in FIG. 1.

In step S602, the object extractor 20 extracts or selects a specific object in the pre-parallax images. This embodiment assumes that a person object surrounded with the solid line illustrated in FIG. 17 is extracted as the background object.

In step S603, the viewing condition obtainer 30 obtains viewing condition information. As described above, the viewing condition information is information on the display size and the visual distance. Further, the information may include information on the number of display pixels or the like. Moreover, for example, the viewing condition may be input using the above-mentioned input interface by the user, and it is possible to be configured so as to preliminarily store information on the display size and the visual distance by assuming a representative viewing environment and acquire the information.

In step S604, the parallax amount calculator 40 calculates the amount of parallax in the object area which is extracted in step S602. First, the base image selector 41 selects one of the parallax images as a base image for calculating the amount of parallax. Next, the correspondence point extractor 42 extracts correspondence points between the parallax image as the base image and the parallax image as the reference image. Next, the parallax amount calculator 40 calculates the amounts of parallax (Pl−Pr) among correspondence points which are extracted.

In step S605 (three-dimensional determination step), the three-dimensional appearance determiner 50 determines whether the three-dimensional effect to a viewer in the object is objected, based on the calculated amount of parallax of the object. First, the allowable parallax lower limit obtainer 51 obtains the allowable parallax lower limit information. Next, the three-dimensional determiner 50 selects an evaluation point in the object by defining the tip of nose as the object i and by defining the ear of the extracted object as the object j, as exemplified in FIG. 17. Next, the three-dimensional appearance determiner 50 determines whether to satisfy the above-mentioned expression 19 by using the allowable parallax lower limit δt, the amount of parallax at the selected evaluation point, and the visual distance that is the viewing condition obtained in the previous step. When the expression 19 is satisfied, that is, the determination is “YES”, the object extracted as described above can make the viewer feel the three-dimensional effect, and therefore the object is determined as three-dimension (3D) in step S606. In contrast, the expression 19 is not satisfied, that is, the determination is “NO”, the object extracted as described above cannot make the viewer feel the three-dimensional effect, and therefore the object is determined as plane (2D) in step S607.

In step S608, when the object is determined as plane in step S607, the system controller 106 controls the contents displayed on the image display 109 via the display controller 110 (image pickup apparatus controller) on the basis of the determination result in step S607. The contents of the display that is controlled in this embodiment are advice information for a user about a method of controlling a focal length of each image pickup optical system and a base length that is the distance between the optical axes of both image pickup optical systems. When the object is determined as plane, the three-dimensional appearance of the object can be improved by extending the focal length to the telephoto end (by causing the angle of view to be narrowed). Further, the three-dimensional appearance of the object also can be improved by changing the base length so that the distance between the optical axes. The processing returns to step S601 again by the user's controlling the image pickup parameters on the basis of the advice information whose display is controlled in step S608, and the pre-image taking of the right and left parallax images is started.

When the object is finally determined as a three-dimension in step S606, a full-pushing of a release switch (not illustrated) becomes possible in step S609, and a final image taking of the right and left parallax images is performed.

In step S610, the parallax image taken in step S609 is stored into an image data file. The image taking result may be displayed on the image display 109, and also may be stored in a storage medium (not illustrated) or the like separately

Although this embodiment describes that the advice information for a user is displayed in step S608, it is possible to perform only a control of simply displaying a warning on the image display 109.

It is also possible to provide a determination cancel mechanism or the like that is capable of forcibly transferring the processing to step S609 by the determination of the user to perform the final image taking when the object is determined as plane in step S607. In this case, it is preferred that the taken image is viewed as 2D image because the object cannot be viewed as three-dimension.

As described above, it is possible to determine whether the above-mentioned harmful effect (flattening, cardboard effect, miniature effect) is caused in the three-dimensional image by determining the three-dimensional appearance of the objet in the parallax images. Therefore, it becomes possible to easily perform an effective determination of the image-taking of the three-dimensional image, and a high quality image-taking of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S601 to S603 shown in the flow can be changed in many ways.

### Embodiment 7

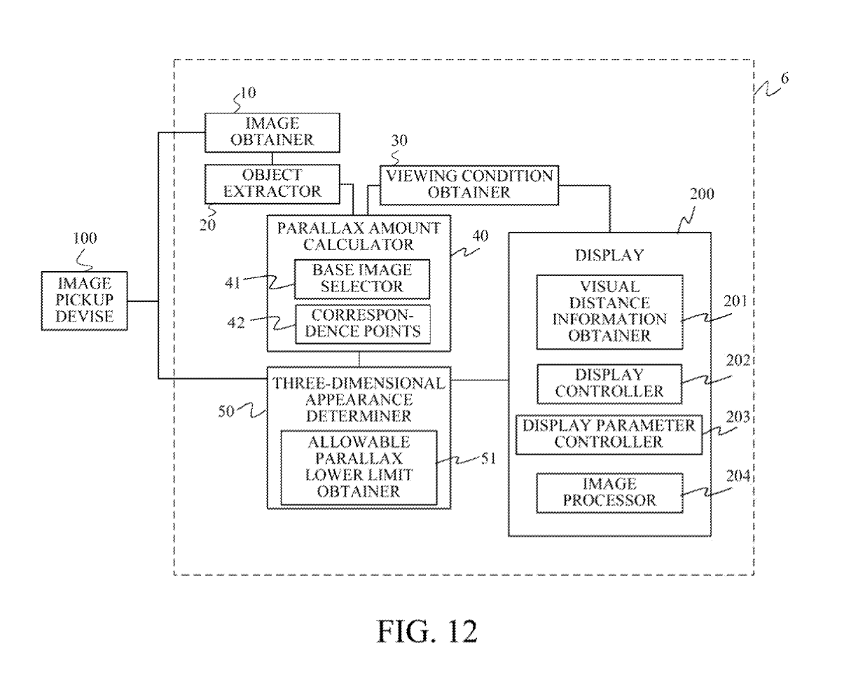

FIG. 12 is a block diagram of a display apparatus 6 that is capable of displaying a three-dimensional image in embodiment 7. The explanation that overlaps with embodiment 1 is omitted. The display apparatus 6 determines, for the parallax images taken from different points of view, the three-dimensional appearance in the parallax images using the allowable parallax lower limit in order to view a three-dimensional image without the harmful effects.

First, the configuration of the display apparatus 6 will be described with reference to FIG. 12. The image obtainer 10, the object extractor 20, the viewing condition obtainer 30, the parallax amount calculator 40 and the three-dimensional appearance determiner 50 have the same configurations as those in embodiment 1, and therefore the explanation thereof is omitted. A display 200 can display the three-dimensional image which the viewer can view stereoscopically in the obtained right and left parallax images. For example, there is a method of displaying the right eye image and the left eye image on one screen with time division and of viewing the displayed image using a liquid crystal shutter glasses which is synchronized with the time division of the screen. A visual distance information obtainer 201 obtains a visual distance of the viewer's viewing the display apparatus. The display controller 202 controls the contents displayed on the display 200. A display parameter controller 203 controls display parameters. The display parameters controlled in embodiment 7 are a display size of the display 200 and offset amounts for adjusting positions of the parallax images. An image processing apparatus 204 executes image processings, such as edge reinforcement and color equation, which are performed to a common two dimensional image or an moving image by a traditional TV apparatus or the like.

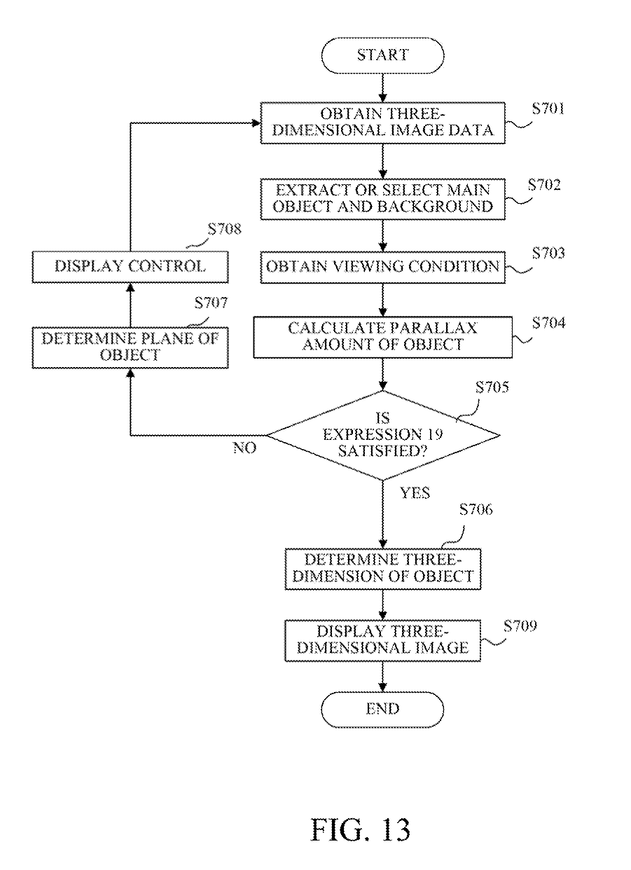

Next, a processing operation in a display apparatus of this embodiment will be described with reference to a flow chart in FIG. 13. First, in step S701, the image obtainer 10 obtains for example the three-dimensional image data from the image pickup. The method of obtaining data may be performed by a direction connection using a USB cable (not illustrated) or the like, and may be performed by a wireless connection (wireless communication) using an electric wave, an infrared ray or the like.

In step S702, the object extractor 20 extracts or selects a specific object in the parallax images included in the three-dimensional image data. This embodiment assumes that a person surrounded with the solid line illustrated in FIG. 17 is extracted as the main object, and a mountain surrounded with the broken line is extracted as the background object.

In step S703, the viewing condition obtainer 30 obtains viewing condition information. As described above, the viewing condition information is information on the display size and the visual distance. Further, the viewing condition information may include information on the number of display pixels or the like. Furthermore, the information on the visual distance is obtained from the visual distance information obtainer 201. In order to obtain visual distance information, it is also possible to adopt, for example, a configuration of measuring a position of the viewer by radiating infrared rays or the like from a display and by measuring a reflection wave thereof. Moreover, it is possible to adopt a configuration of specifying a position of the viewer using a common facial recognition technology by providing a small image pickup apparatus on the side of the display.

In step S704, the parallax amount calculator 40 calculates the amount of parallax in an object area which is extracted in step S702. First, the base image selector 41 selects one of the parallax images as a base image for calculating the amount of parallax. Next, the correspondence point extractor 42 extracts correspondence points between the parallax image as the base image and the parallax image as the reference image. Next, the parallax amount calculator 40 calculates the amounts of parallax (Pl−Pr) among correspondence points which are extracted.

In step S705 (three-dimensional determination step), the three-dimensional appearance determiner 50 determines whether the three-dimensional effect to a viewer in the object is objected, based on the calculated amount of parallax of the object. First, the allowable parallax lower limit obtainer 51 obtains the allowable parallax lower limit information. Next, the three-dimensional appearance determiner 50 selects an evaluation point in the object by defining the tip of nose as the object i and by defining the ear of the extracted object as the object j, as exemplified in FIG. 17. Next, the three-dimension determiner 50 determines whether to satisfy the above-mentioned expression 19 by using the allowable parallax lower limit δt, the amount of parallax at the selected evaluation point, and the visual distance that is the viewing condition obtained in the previous step. When the expression 19 is satisfied, that is, the determination is “YES”, the object extracted as described above can make the viewer feel the three-dimensional effect, and therefore the object is determined as three-dimension (3D) in step S706. In contrast, the expression 19 is not satisfied, that is, the determination is “NO”, the object extracted as described above cannot make the viewer feel the three-dimensional effect, and therefore the object is determined as plane (2D) in step S707.

In step S708, when the object is determined as plane in step S707, the display controller 202 (display apparatus controller) controls the contents displayed on the display 200 on the basis of the determination result in step S707. The contents of the display that is controlled in this embodiment are advice information for the viewer about a display size of displaying the three-dimensional image and a visual distance that is the distance between the viewer and the display apparatus. When the object is determined as plane, the three-dimensional appearance of the object can be improved by extending the focal length.

Further, the three-dimensional appearance of the object also can be improved by changing the visual distance so that the distance to the display apparatus is shortened. On the basis of the advice information whose display is controlled in step S708, the user adjusts the viewing conditions or the display parameter controller 203 (display apparatus controller), which controls the display conditions of influencing the three-dimensional appearance, automatically controls the image, and the processing returns to step S701 to start the control again.

When the object is finally determined as a three-dimension in step S706, the display of the three-dimensional image is performed in step S709.

Although this embodiment describes that the advice information for the viewer is displayed in step S708, it is possible to perform only a control of simply displaying a warning on the display 200. In this case, these are not intended to force the viewer to perform the control, and it is possible to perform the display of the three-dimensional image without change. However, in this case, it is preferred that the taken image is viewed as 2D image because the object cannot be viewed as three-dimension.

As described above, it is possible to determine whether the above-mentioned harmful effect (flattening, cardboard effect, miniature effect) is caused in the three-dimensional image by determining the three-dimensional appearance of the objet in the parallax images. Therefore, it is possible to easily perform an effective determination of the display of the three-dimensional image, and a high quality display of the three-dimensional image can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In particular, the sequence of S701 to S703 shown in the flow can be changed in many ways.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

This application claims the benefit of Japanese Patent Application No. 2012-032773, filed on Feb. 17, 2012, which is hereby incorporated by reference herein in its entirety.

What is claimed is:

1. An image processing apparatus capable of generating a three-dimensional image, comprising:
an image obtainer configured to obtain a parallax image;
an object extractor configured to extract at least a first object and a second object in the parallax image that is obtained by the image obtainer;
a parallax amount calculator configured to calculate an amount of parallax of each of the first object and the second object that are extracted by the image extractor;
a viewing condition obtainer configured to obtain a viewing condition when the three-dimensional image is displayed; and
a three-dimensional appearance determiner configured to, by using the viewing condition and the amounts of parallax of the first and second objects that are calculated by the parallax amount calculator,
determine that a three-dimensional appearance is obtained when a difference between the amounts of parallax of the first and second objects is not less than a predetermined value, and
determine that the three-dimensional appearance is not obtained when the difference is less than the predetermined value.

2. An image pickup apparatus capable of generating a three-dimensional image, comprising:
an image pickup device configured to take an image of an object at different points of view to obtain a plurality of parallax images;
an object extractor configured to extract at least a first object and a second object in the parallax image that is obtained by the image obtainer;
a parallax amount calculator configured to calculate an amount of parallax of each of the first object and the second object that are extracted by the image extractor;
a viewing condition obtainer configured to obtain a viewing condition when the three-dimensional image is displayed;
a three-dimensional appearance determiner configured to, by using the viewing condition and the amounts of parallax of the first and second objects that are calculated by the parallax amount calculator,
determine that a three-dimensional appearance is obtained when a difference between the amounts of parallax of the first and second objects is not less than a predetermined value, and
determine that the three-dimensional appearance is not obtained when the difference is less than the predetermined value; and
an image pickup apparatus controller configured to control the image pickup apparatus according to a determination result of the three-dimensional appearance determiner.

3. The image pickup apparatus according to claim 2,
wherein the image pickup apparatus controller includes an image pickup parameter controller configured to control an image pickup condition that affects the three-dimensional appearance, and
wherein the parallax amount calculator calculates the amount of parallax of each of the first object and the second object based on the image pickup condition.

4. The image pickup apparatus according to claim 2, further comprising an image display,
wherein the image pickup controller includes a display controller configured to control a content displayed on the image display according to the determination result of the three-dimensional appearance determiner.

5. The image pickup apparatus according to claim 4, wherein the display controller displays information corresponding to at least one of a visual distance and a display size of the three-dimensional image.

6. The image pickup apparatus according to claim 5, wherein the display controller increases the display size of the three-dimensional image when the three-dimensional appearance determiner determines that the three-dimensional appearance is not obtained.

7. A display apparatus capable of displaying a three-dimensional image, comprising:
an image obtainer configured to obtain a parallax image;
an image display configured to display the parallax image obtained by the image obtainer;
an object extractor configured to extract at least a first object and a second object in the parallax image that is obtained by the image obtainer;
a parallax amount calculator configured to calculate an amount of parallax of each of the first object and the second object that are extracted by the image extractor;
a viewing condition obtainer configured to obtain a viewing condition when the three-dimensional image is displayed;
a three-dimensional appearance determiner configured to, by using the viewing condition and the amounts of parallax of the first and second objects that are calculated by the parallax amount calculator,
determine that a three-dimensional appearance is obtained when a difference between the amounts of parallax of the first and second objects is not less than a predetermined value, and
determine that the three-dimensional appearance is not obtained when the difference is less than the predetermined value; and
a display apparatus controller configured to control the display apparatus according to a determination result of the three-dimensional appearance determiner.

8. The display apparatus according to claim 7,
wherein the display apparatus controller includes a display parameter controller configured to control a display condition that affects the three-dimensional appearance, and
wherein the parallax amount calculator calculates the amount of parallax of each of the first object and the second object based on the display condition.

9. The display apparatus according to claim 7, wherein the display apparatus controller includes a display controller configured to control a content displayed on the image display according to the determination result of the three-dimensional appearance determiner.

10. The display apparatus according to claim 9, wherein the display controller displays information corresponding to at least one of a visual distance and a display size of the three-dimensional image.

11. The display apparatus according to claim 10, wherein the display controller increases the display size of the three-dimensional image when the three-dimensional appearance determiner determines that the three-dimensional appearance is not obtained.
